(19) United States
(12) Patent Application Publication
(10) Pub. No.: US 2026/0254732 A1
(43) Pub. Date: Aug. 27, 2026

(54) Methods for Predicting Application-Layer Characteristics in Cellular Networks Using Lower-Layer Metrics

(71) Applicant: Northeastern University, Boston, MA (US)

(72) Inventors: Tommaso MELODIA, Newton, MA (US); Reshma PRASAD, Boston, MA (US); Salvatore D'ORO, Brookline, MA (US); Leonardo BONATI, Boston, MA (US)

(21) Appl. No.: 19/552,631

(22) Filed: Feb. 27, 2026

Related U.S. Application Data
(60) Provisional application No. 63/764,513, filed on Feb. 27, 2025.

(51) Int. Cl. H04L 41/5009; H04L 5/00; H04L 41/16; H04W 24/08; H04W 28/02

(52) U.S. Cl. CPC H04L 41/5009; H04L 5/0053; H04L 41/16; H04W 24/08; H04W 28/0278

(57) ABSTRACT

Methods and systems are provided to predict wireless network behavior experienced by users using data obtained from a cellular base station and without using data from user equipment. Artificial intelligence is used with radio access network (RAN) control applications to improve the overall performance of the network. Key performance metrics (KPMs) are collected from the RAN and a machine learning model is used to predict application layer KPMs (performance of user equipment). The predicted application layer metrics are used to optimize performance of the network, including reducing latency and increasing throughput.

### CROSS REFERENCE TO RELATED APPLICATIONS

This application claims the priority of U.S. Provisional Application No. 63/764,513 filed on 27 Feb. 2025 and entitled “Methods for Predicting Application-Layer Characteristics in Cellular Networks Using Lower-Layer Metrics”, the whole of which is hereby incorporated by reference.

### STATEMENT REGARDING FEDERALLY SPONSORED RESEARCH OR DEVELOPMENT

This invention was made with government support under Grant Number W911NF-19-2-0221 awarded by the U.S. Army Research Office, and under Grant Number 25-60-IF002 awarded by the National Institute of Standards and Technology. The government has certain rights in the invention.

### BACKGROUND

Cellular networks such as 5G and beyond are evolving toward a new generation of Radio Access Networks (RANs) driven by data-centric intelligence and adapting to dynamic requirements and demands. Like any intelligent system, RANs rely on data for decision making, highlighting the importance of using and interpreting relevant data for optimizing network performance and user experience. The available data for this purpose are diverse in timescales and content, ranging from network data accessible to the RAN, to end-user Quality of Service (QoS) data available at user equipment (UE).

The primary aim of network operators in leveraging intelligence in networks is to enhance end-user performance while ensuring high data rates, low latency, and reliability across a vast number of connected devices. Higher-layer factors such as application performance, and end-to-end network conditions affect the complexities of user experience. Accurate information about users is needed to make important decisions such as resource management, as users are heterogeneous and have diverse QoS requirements. However, operators only have access to RAN Key Performance Metrics (KPMs) in real-time, making it hard to design intelligent algorithms that can improve end-user experience while relying solely on low-layer data as input. The limitation of using lower-layer data is demonstrated in [1] (hereby incorporated by reference in its entirety), where the authors show that throughput at the medium access control (MAC) layer is always higher than application layer (APP-layer) throughput. The authors highlight that a UE that meets a certain MAC layer data rate does not necessarily meet an APP-layer target value due to retransmissions and overhead.

Unfortunately, measuring user-level application performance is difficult with current network architectures. To address this, 5G networks have introduced a core network function, Network Data Analytics Function (NWDAF), designed to enable intelligence by collecting data from various sources such as core network functions and network exposure function, and then analyze the data collected [2] (hereby incorporated by reference in its entirety). But leveraging this information in real-time at the RAN level is not always feasible. For instance, O-RAN, the open RAN architecture specified by the O-RAN Alliance, introduces RAN intelligent controllers (RICs) to control RAN functionalities. These controllers include xApps, that operate in near-real time, and rApps that operate in non-real time. Typically, an xApp gets data from NWDAF through a series of steps. First, NWDAF collects the data from core network functions. These data are then sent to the non-RT RIC, or to the Service Management and Orchestration framework (SMO), which forwards it to the near-RT RIC (e.g., over the AI interface) as enrichment information before finally reaching the xApp. This multi-step process introduces delays, making it unsuitable for real-time optimizations required for rapid network adaptations. This multi-step process is shown in FIG. 1.

The RAN is widely recognized as the bottleneck in the overall network, being the major contributor to latency and other metrics [3]. Indeed, the RAN must handle resource allocation dynamically in real-time, dealing with its unpredictability caused by instantaneous radio conditions, resource scarcity, and time-varying capacity. This directly impacts metrics such as latency and throughput and makes the network more susceptible to latency bottlenecks, in contrast to the core network, which benefits from high-capacity fiber links and centralized processing. Core networks are designed for high-speed packet switching and can often leverage Software-Defined Networking (SDN) or Network Function Virtualization (NFV) to optimize routing and processing. Thus, optimized core networks exhibit predictable delays that are less sensitive to user mobility or instantaneous demand variations. As a result, leveraging detailed information from the RAN to predict application-level performance metrics could provide valuable insights, making it a promising candidate for enhancing network optimization. However, accurately predicting the user application layer KPMs is a challenging task because of factors such as lack of formal optimization models, complex dependencies between different attributes, and the dynamic nature of network.

### SUMMARY

The present technology provides methods to predict wireless network behavior experienced by users using data obtained from a cellular base station. The methods can be used in artificial intelligence-based radio access network (RAN) control applications to improve the overall performance of the network. In particular, the present methods and systems collect key performance metrics (KPMs) from the RAN and apply machine learning models to predict application layer KPMs. The predicted application layer metrics can then be used to optimize performance of the network.

The present data-driven methods can predict application-layer performance using lower-layer RAN metrics. By identifying relevant RAN metrics and leveraging a tunable sliding window, statistical behavior can be forecast and used instead of relying on instantaneous values, enabling AI-driven network optimization and improved user experience.

The present methods are the first that predict application-layer characteristics from lower layer metrics obtained from a base station. The approach enables simultaneous prediction of multiple characteristics. Additionally, the present methods can be tailored for users based on their differing service requirements. The methods empower AI control applications to enhance network efficiency and user satisfaction. The present technology bridges the gap between RAN KPMs and end-user quality of service (QoS) data, enabling real-time adaptation to user needs. The technology also can be used by network operators to make network predictions based on historical data.

The effectiveness of the present methods was validated in static dataset and real-time scenarios by deploying them in the Open RAN Colosseum testbed.

The present technology can be further summarized with the following listing of features.
1. A method for operating a radio access network (RAN), comprising:
   (i) collecting RAN key performance metrics (RAN KPMs) from one or more layers of the RAN, wherein the RAN KPMs comprise lower layer metrics;
   (ii) transmitting the collected RAN KPMs to an xApp running in a near-real-time RAN intelligent controller of the RAN;
   (iii) processing, by the xApp, the RAN KPMs to generate one or more short-term radio performance indicators;
   (iv) predicting, by the xApp, one or more application layer KPMs at a user equipment using the RAN KPMs and/or the short-term radio performance indicators and one or more machine learning models, wherein the application layer KPMs characterize end user application performance; and
   (v) operating the RAN using the predicted application layer KPMs.
2. The method of feature 1, wherein the RAN-KPMs include one or more physical layer metrics and/or base station monitoring statistics.
3. The method of feature 1 or feature 2, wherein the RAN-KPMs include one or more of direct RAN metrics, sliding average RAN metrics, derived RAN metrics, or one or more control or decision parameters.
4. The method of any of the preceding features, wherein the RAN-KPMs include one or more of buffer size, size of a downlink buffer queue, buffer status reports, slicing parameters, throughput at a medium access control layer, error rate, retransmission counts, acknowledgment/negative-acknowledgment ratios, modulation and coding scheme values, downlink throughput, or downlink channel quality indicator reported by user equipment.
5. The method of any of the preceding features, wherein the application layer KPMs include one or more of end user latency, app throughput, error rate, or jitter.
6. The method of any of the preceding features, wherein step (ii) comprises transmitting the collected RAN-KPMs to a near-real-time RAN intelligent controller running the xApp.
7. The method of any of the preceding features, wherein the one or more short-term radio performance indicators include sliding average values determined for one or more RAN-KPMs.
8. The method of any of the preceding features, wherein step (iv) is performed without requiring collection of application layer measurements as input or without using a network data analytics function.
9. The method of any of the preceding features, wherein step (v) comprises modifying RAN control to add more network resources to a user.
10. The method of any of the preceding features, wherein the machine learning model is created by a process comprising data collection, model design, model training, and model testing.
11. The method of any of the preceding features, wherein the RAN is part of a 5G or 6G network.
12. The method of any of the preceding features, wherein the method results in a latency of less than about 150, 120, 110, 100, 90, 80, 70, 60, or 50 ms at 90^{th} percentile.
13. The method of any of the preceding features, wherein the method results in a throughput of at least about 0.5, 0.6, 0.7, 0.8, 0.9, 1.0, 1.1, 1.2, or 1.5 Mbps.
14. A system comprising a processor and memory comprising instructions for carrying out the method of any of the preceding features.
15. A non-transitory, computer readable medium comprising instructions, which when executed by processing circuitry in a RAN, cause the RAN to
   (i) collect RAN key performance metrics (RAN KPMs) from one or more layers of the RAN, wherein the RAN KPMs comprise lower layer metrics;
   (ii) transmit the collected RAN KPMs to an xApp running in a near-real-time RAN intelligent controller of the RAN;
   (iii) cause the xApp to generate one or more short-term radio performance indicators based on one or more of the RAN KPMs;
   (iv) cause the xApp to predict one or more application layer KPMs at a user equipment using the RAN KPMs and/or the short-term radio performance indicators and one or more machine learning models, wherein the application layer KPMs characterize end user application performance; and
   (v) operate the RAN using the predicted application layer KPMs.

### BRIEF DESCRIPTION OF THE DRAWINGS

FIG. 1 shows the architecture of an O-RAN that utilizes a network data analytics function (NWDAF).

FIG. 2A shows an embodiment of an O-RAN that does not utilize a NWDAF, but instead uses one or more machine learning models that use collected RAN KPM data to predict application layer KPMs. FIG. 2B shows an embodiment of a workflow for developing a machine learning model to process RAN KPM data and predict application layer KPMs.

FIG. 3A shows a matrix for correlation of RAN KPMs with application level end-to-end latency for eMBB users. FIG. 3B shows a matrix for correlation of RAN KPMs with application level end-to-end latency for URLLC users.

FIG. 4A shows plots of actual vs. predicted latency and bitrate for testing using a static data set. FIG. 4B shows plots of actual vs. predicted latency and bitrate for testing in real time using Colosseum.

### DETAILED DESCRIPTION

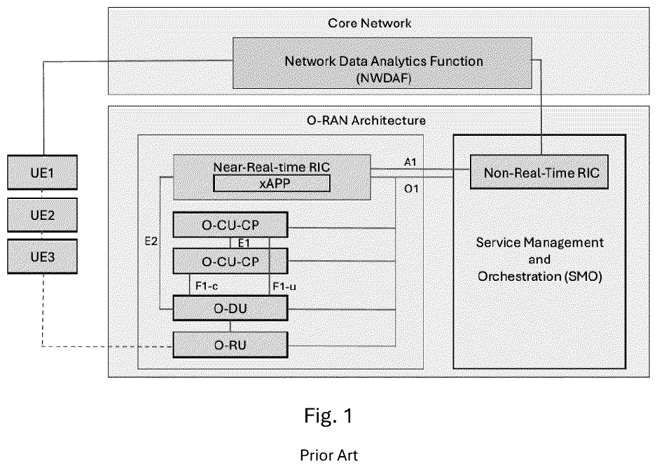

The present technology leverages the potential of lower-layer metrics obtained from cellular base stations (RAN and MAC layer data) and utilizes data-driven methods to predict application layer characteristics. The technology contemplates an Open RAN scenario in which the base station supports a set of network slices such as Enhanced Mobile Broadband (eMBB) and Ultra Reliable and Low Latency Communications (URLLC), and the traffic generated by user equipment is classified into these slices. In O-RAN, the traditional base station architecture is disaggregated into three distinct functional units: Central Unit (CU), Distributed Unit (DU), and Radio Unit (RU) (see FIG. 1). The split ensures more flexibility in deployment and facilitates multi-vendor interoperability. O-RAN also enables intelligent closed-loop control over RAN network functionalities via the RAN intelligent controllers (RICs). These include a near-real-time RIC that enables applications (xApps) providing fine-grained control and operating in the 10 ms to 1 s range, and a non-real-time RIC that supports applications (rApps) providing coarse-grained control functioning over a timeframe of a few seconds.

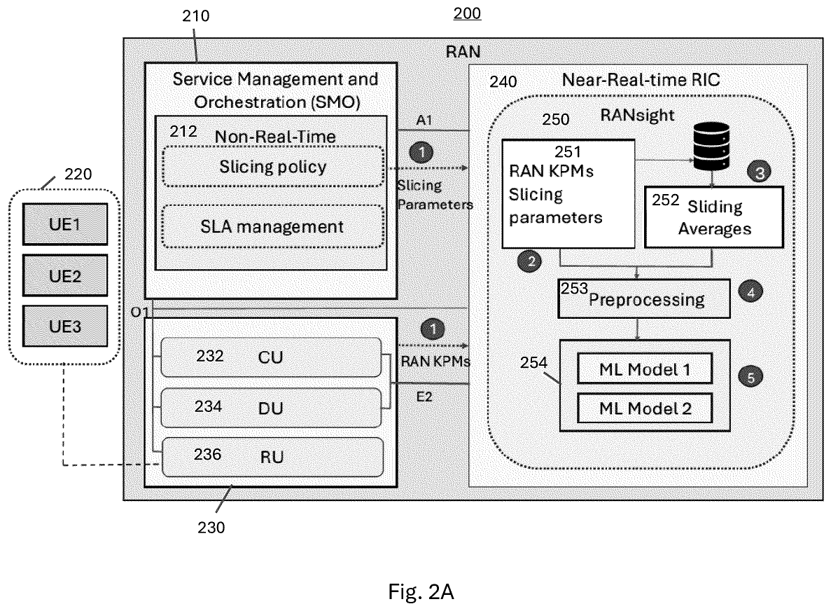

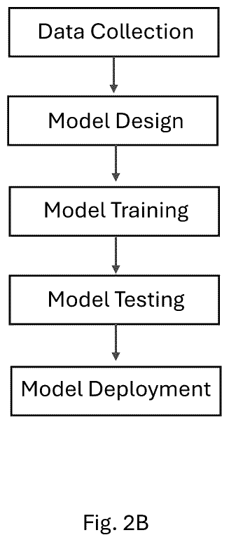

The present technology provides a framework that predicts APP-layer KPMs by leveraging only real-time RAN KPMs. The present framework is provided as an architectural component within the O-RAN framework. FIG. 2 illustrates the interactions between network elements and prediction mechanisms in an embodiment of the present framework. In this embodiment, an xApp named RANsight eliminates delays that would be encountered in architectures that rely on NWDAF by running directly in the near-real-time RIC, enabling real time decision making without multi-step processing latency.

The framework embodiment 200 shown in FIG. 2A operates according to a five-step process. The first step 1 of the process is data collection, during which the near-real-time RIC 240 receives RAN KPMs from both the non-real-time RIC 212 of the SMO 210 through the AI interface and from the base station 230 units CU 232, DU 234, and RU 236 through the E2 interface. The RAN KPMs include metrics such as size of the downlink buffer queue, downlink throughput, downlink channel quality indicator (CQI) reported by UEs 220. Near-RT RIC 240 also receives slicing parameters through the AI interface. In step 2, once the data are obtained, the near-real-time RIC makes the collected data available to the xApp RANsight 250. In step 3, the stored KPMs 251 are used to generate sliding averages 252, which serve as short-term performance indicators to capture recent trends. In step 4, RANsight performs data preprocessing 253 to prepare for prediction of application layer KPMs in step 5 by one or more machine learning models 254 using the processed data.

In response to the prediction of application layer KPMs, one or more RAN control functions can be modified to proactively improve the user experience, such as by reducing latency and/or increasing data throughput. RAN control usually targets the end user quality of experience (QoE). However, RAN KPMs do not correlate precisely with QoE. For example, RAN throughput includes retransmissions, so it is generally higher than application-layer throughput, which is what truly represents QoE; this makes RAN KPMs an imperfect indicator by which to tailor RAN functions so as to maximize QoE or meet a target min/max level (e.g., minimum app-layer throughput value or maximum latency). But the present technology makes it possible to use RAN KPMs to estimate app-layer KPMs, and use that estimate to control RAN functions accordingly, to allocate more resources to a user, for example.

As an example of a machine learning workflow, the following five step process can be followed (see FIG. 2B and reference [4], which is hereby incorporated by reference in its entirety). The first step is data collection, for which steps 1-4 discussed above and depicted in FIG. 2A can be used, for example. The second step is model design. The third step is model training. The fourth step is model testing. Finally, the fifth step is model deployment as part of an xApp, where the model is used for runtime inference and control. Any suitable machine learning model, or combination of such models, can be used. The model or models can be trained using, for example, real or simulated 5G network data.

The system obtains RAN KPMs as input in real time. These KPMs range from physical layer metrics to base station monitoring statistics, and thus can be numerous. The bulk set of data may not be useful to represent the network state for a specific problem, so selection of relevant metrics can be performed. The relationship between RAN KPMs and the application layer KPMs can be complex, and different RAN metrics can contribute to application performance with varying degrees of significance. For instance, buffer size at base station has a direct and proportional impact on latency. Apart from the metrics with direct relationships, control and decision parameters such as slice type, resource allocation, and scheduling policies can have nuanced and indirect effect on application layer KPMs. Therefore, a key step in the design process of machine learning-driven xApps is the selection of the features that should be reported for RAN closed-loop control. To this end, the correlation was studied between the actual and averaged KPMs under consideration for users belonging to different network slices, e.g., eMBB and URLLC users. The correlation analysis helps to identify the KPMs that provide a meaningful description of the network state with minimal redundancy. See examples presented below.

5G networks are characterized by highly dynamic channel conditions, which can change rapidly due to factors like user mobility, environmental changes, and interference from other devices. This variability can significantly impact the quality of the service perceived by users. In scenarios where channels fluctuate frequently, accurate forecasting of KPMs becomes increasingly difficult, and thus instantaneous real-time KPMs values may not be sufficient to build an accurate prediction model [5]. To address this challenge, a tunable sliding window was leveraged that collects data from the recent past. By leveraging such historical data, the model can focus on capturing the statistical behavior of the KPMs rather than making predictions based solely on transient fluctuations. This approach enables the forecasting of the overall distribution of KPMs, providing network operators with valuable insights into their statistical patterns and aiding in more informed decision-making.

Different types of RAN KPMs can be used in the methods and systems disclosed herein. These include the following types of RAN metrics: (i) direct RAN metrics, which are expected to have substantial impact on application-layer metrics; (ii) sliding-averaged metrics, which are RAN metrics averaged over a time window, that capture short-term trends; (iii) derived metrics, which are indirect metrics derived from RAN metrics that offer additional insights; and (iv) control and decision parameters, such as resources allocated to the network slice corresponding to the user traffic.

### EXAMPLES

### Example 1. Experimental Setup

To test the efficiency of the methods in real time, Colosseum, the largest Open RAN emulator [6], was used and OpenRAN Gym was leveraged to instantiate an Open RAN deployment on Colosseum. Colosseum replicates Radio Frequency (RF) conditions through its Massive Channel Emulator (MCHEM), enabling realistic testing of various scenarios. In this setup, the UEs request heterogeneous traffic profiles corresponding to diverse network slice classes, such as eMBB and URLLC. These traffic profiles are emulated using a traffic emulation system based on the Multi-Generator (MGEN), ensuring accurate representation of slice-specific traffic dynamics.

A dataset was used that was twinned from real-world cellular traffic in the instantiated O-RAN deployment at the Colosseum testbed. The dataset used herein is described in detail in [1]. The dataset is collected from experiments consisting of a base station and 8 UEs belonging to eMBB and URLLC slices. The application-level KPMs used during the training phase were collected using MGEN on Colosseum. Specifically, each UE was equipped with an MGEN receiver that calculated application-layer KPMs based on the packet payloads of transmitted packets sent by the MGEN transmitter.

The dataset has more than 35 time-stamped KPMs collected from the base station and MGEN for different users and traffic demand. Furthermore, the dataset includes details on the slice configuration, such as the resources allocated to eMBB and URLLC slices and the scheduling policies employed. The data from the base station was periodically reported at a time interval of 250 ms.

The performance of the designed model for eMBB users was tested in static and real-time scenarios, focusing on predicting latency and throughput experienced in application layer for the evaluation. A sliding window size of 6 was used and, in the LSTM model, a sequence length of 3.

### Example 2. Model Design

It is noted that certain APP-layer KPMs exhibit significant skewness in their data distribution. The unevenness in data causes a bias in the model's learning process, causing it to favor the majority class, making generalization challenging and using the values in the control loop may lead to suboptimal performance. For example, if APP-layer latency is typically low but has occasional spikes due to congestion as observed in URLLC data, a model trained without handling skewness may always predict low latency. To mitigate this, two key strategies can be followed: the first one is to handle skewness by applying proper data preprocessing techniques, and second is to design a machine learning model that can learn from the imbalanced data. Thus, distinct approaches were designed for KPMs that exhibit a skewed data distribution and for ones that are not skewed.

For the data that was not skewed, for instance, eMBB latency data, Long-Short Term Memory (LSTM) was used, which is a modified version of Recurrent Neural Networks. The data were scaled using MinMaxScaler and then provided as input to the LSTM model. In the LSTM model, a LSTM layer with 50 units was used. The model consisted of a dense layer with 30 neurons and ReLU activation and another dense layer that predicts the values.

For the skewed data, the input data were normalized using MinMaxScaler and at the same time, logarithmic transformation together with RobustScaler was applied to normalize the target variables during training. An XGBRe-gressor model was employed, which is an implementation of Gradient Boosting based on Extreme Gradient Boosting (XGBoost). The maximum depth of individual decision trees was set as 20. Minimum child weight was set to 16 to prevent overfitting. The minimum loss reduction y was set as 0.4, and base score was set as mean of target values to provide a reasonable starting point for the boosting process.

### Example 3. Results

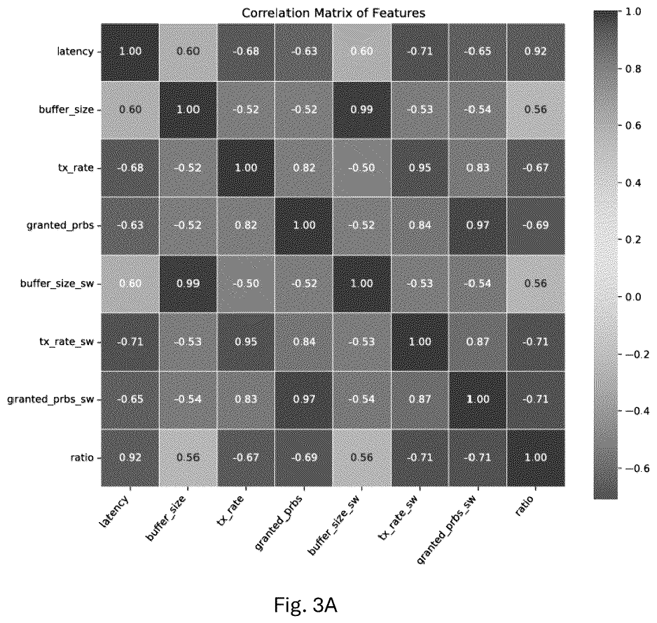

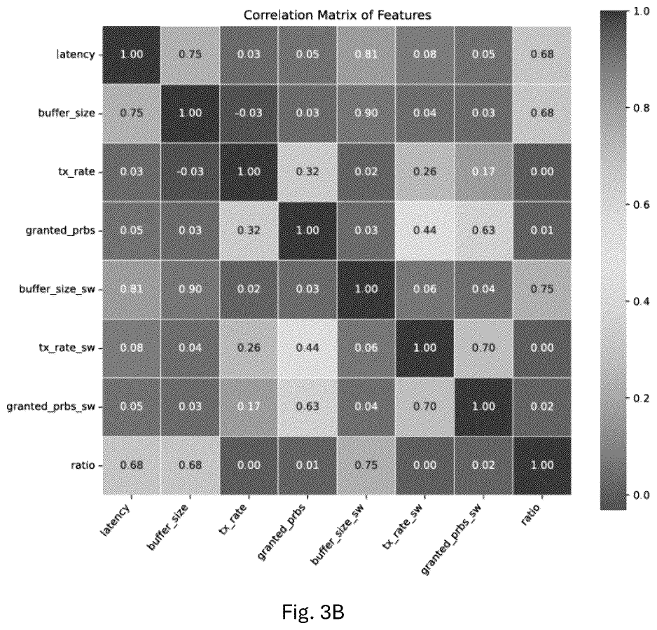

FIGS. 3A and 3B illustrate the correlation between the actual metrics and the sliding-window averaged metrics for eMBB and URLLC users, respectively. The figures focus on metrics with an absolute correlation value above a threshold of 0.5 with respect to application-level latency. In these figures, latency indicates the application-level latency, buffer_size, tx_rate, granted prbs indicate the RAN KPMs, buffer_size-sw, tx_rate sw, granted prbs_sw indicate the sliding window averaged values and ratio indicates the relative difference between the total requested PRBs and the granted PRBs, normalized by the granted PRBs. Ratio is a derived metric and shows whether resources are under-provisioned or over-provisioned, and thus it provides a means to evaluate resource allocation efficiency and identify congestion. The figures highlight a strong correlation between the metrics. This underscores that these actual, sliding window averaged and derived metrics can be used for the prediction model.

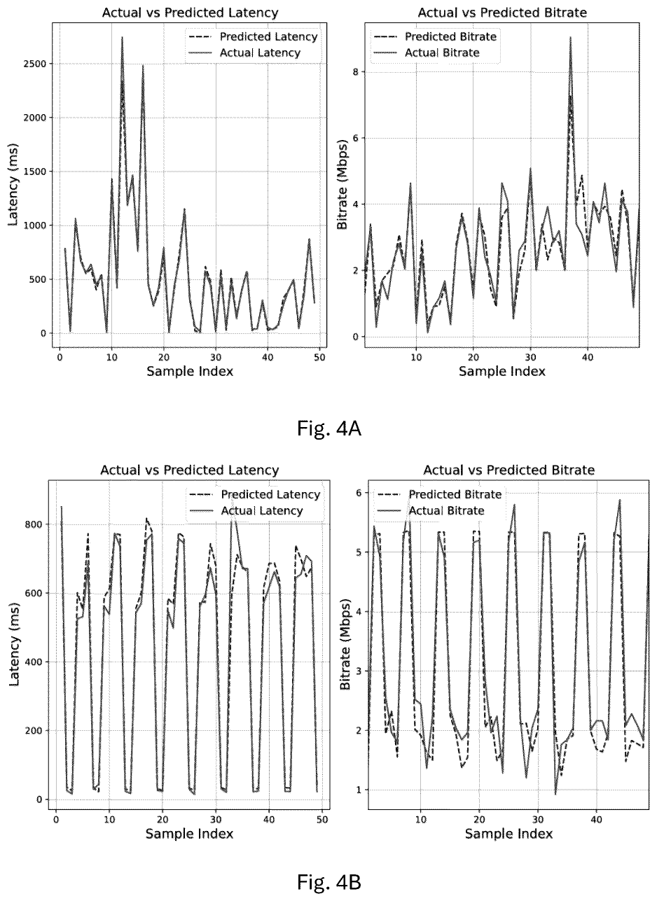

The actual and predicted values of latency and bitrate KPMs on static dataset and real-time deployment for one sample period are shown in FIGS. 4A and 4B, respectively. It can be observed from the samples that the predicted values closely align with the actual values in both static and real-time, highlighting the effectiveness of the model.

The prediction over the static dataset yielded median and mean error of 20.309 ms and 39.14 ms for latency and 0.25 Mbps and 0.38 Mbps for throughput respectively. On the other hand, deployment of the model in real-time yielded median and mean error value of 25.21 ms and 43.79 ms for latency and 0.32 Mbps and 0.43 Mbps for throughput respectively. The absolute error values at 10th, 90th, 95th, 99th percentile that show the lower and upper bounds of error in both scenarios are provided in Tables 1 and 2 respectively.

From Tables 1 and 2, for both static and real time scenarios, it can be seen that the extreme absolute error values are much lower than the worst-case absolute error observed.

TABLE 1
Latency and Rate absolute error Percentile Statistics
results when tested on static data set

| Percentile | Latency (ms) | Rate (Mbps) |
|---|---|---|
| 10th Percentile | 3.42 | 0.0403 |
| 90th Percentile | 82.95 | 0.8816 |
| 95th Percentile | 131.06 | 1.1538 |
| 99th Percentile | 345.62 | 1.8454 |

TABLE 2
Latency and Rate absolute error Percentile Statistics
results when tested real time using Colosseum

| Percentile | Latency (ms) | Rate (Mbps) |
|---|---|---|
| 10th Percentile | 4.1 | 0.0582 |
| 90th Percentile | 102.95 | 0.953 |
| 95th Percentile | 134.95 | 1.219 |
| 99th Percentile | 219.24 | 1.780 |

As used herein, “consisting essentially of” allows the inclusion of materials or steps that do not materially affect the basic and novel characteristics of the claim. Any recitation herein of the term “comprising”, particularly in a listing of components of a composition or elements of a device, constitutes inclusion of alternative embodiments in which “comprising” is replaced with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

1. L. Bonati, R. Shirkhani, C. Fiandrino, S. Maxenti, S. D'Oro, M. Polese, and T. Melodia, “Twinning commercial network traces on experimental open RAN platforms,” arXiv preprint arXiv:2409.16217, 2024.
2. 3GPP, “5G system; network data analytics services,” 3GPP TS 29.520 V16.4.0, 2020.
3. I. Parvez, A. Rahmati, I. Guvenc, A. I. Sarwat, and H. Dai, “A survey on low latency towards 5G: RAN, core network and caching solutions,” IEEE Communications Surveys & Tutorials, vol. 20, no. 4, pp. 3098-3130, 2018.
4. M. Polese, L. Bonati, S. D'Oro, S. Basagni, and T. Melodia, “Colo-ran: Developing machine learning-based xapps for open ran closed-loop control on programmable experimental platforms,” IEEE Transactions on Mobile Computing, vol. 22, no. 10, pp. 5787-5800, 2022.
5. D. Raca, A. H. Zahran, C. J. Sreenan, R. K. Sinha, E. Halepovic, R. Jana, and V. Gopalakrishnan, “On leveraging machine and deep learning for throughput prediction in cellular networks: Design, performance, and challenges,” IEEE Communications Magazine, vol. 58, no. 3, pp. 11-17, 2020.
6. L. Bonati, P. Johari, M. Polese, S. D'Oro, S. Mohanti, M. Tehrani-Moayyed, D. Villa, S. Shrivastava, C. Tassie, K. Yoder et al., “Colosseum: Large-scale wireless experimentation through hardware-in-the-loop network emulation,” in 2021 IEEE International Symposium on Dynamic Spectrum Access Networks (DySPAN). IEEE, 2021, pp. 105-113.

1. A method for operating a radio access network (RAN), comprising:
(i) collecting RAN key performance metrics (RAN KPMs) from one or more layers of the RAN, wherein the RAN KPMs comprise lower layer metrics;
(ii) transmitting the collected RAN KPMs to an xApp running in a near-real-time RAN intelligent controller of the RAN;
(iii) processing, by the xApp, the RAN KPMs to generate one or more short-term radio performance indicators;
(iv) predicting, by the xApp, one or more application layer KPMs at a user equipment using the RAN KPMs and/or the short-term radio performance indicators and one or more machine learning models, wherein the application layer KPMs characterize end user application performance; and
(v) operating the RAN using the predicted application layer KPMs.

2. The method of claim 1, wherein the RAN-KPMs include one or more physical layer metrics and/or base station monitoring statistics.

3. The method of claim 1, wherein the RAN-KPMs include one or more of direct RAN metrics, sliding average RAN metrics, derived RAN metrics, or one or more control or decision parameters.

4. The method of claim 1, wherein the RAN-KPMs include one or more of buffer size, size of a downlink buffer queue, buffer status reports, slicing parameters, throughput at a medium access control layer, error rate, retransmission counts, acknowledgment/negative-acknowledgment ratios, modulation and coding scheme values, downlink throughput, or downlink channel quality indicator reported by user equipment.

5. The method of claim 1, wherein the application layer KPMs include one or more of end user latency, app throughput, error rate, or jitter.

6. The method of claim 1, wherein step (ii) comprises transmitting the collected RAN-KPMs to a near-real-time RAN intelligent controller running the xApp.

7. The method of claim 1, wherein the one or more short-term radio performance indicators include sliding average values determined for one or more RAN-KPMs.

8. The method of claim 1, wherein step (iv) is performed without requiring collection of application layer measurements as input or without using a network data analytics function.

9. The method of claim 1, wherein step (v) comprises modifying RAN control to add more network resources to a user.

10. The method of claim 1, wherein the machine learning model is created by a process comprising data collection, model design, model training, and model testing.

11. The method of claim 1, wherein the RAN is part of a 5G or 6G network.

12. The method of claim 1, wherein the method results in a latency of less than about 150 ms at 90th percentile.

13. The method of claim 1, wherein the method results in a throughput of at least about 0.5 Mbps.

14. A system comprising a processor and memory comprising instructions for carrying out the method of claim 1.

15. A non-transitory, computer readable medium comprising instructions, which when executed by processing circuitry in a RAN, cause the RAN to
(i) collect RAN key performance metrics (RAN KPMs) from one or more layers of the RAN, wherein the RAN KPMs comprise lower layer metrics;
(ii) transmit the collected RAN KPMs to an xApp running in a near-real-time RAN intelligent controller of the RAN;
(iii) cause the xApp to generate one or more short-term radio performance indicators based on one or more of the RAN KPMs;
(iv) cause the xApp to predict one or more application layer KPMs at a user equipment using the RAN KPMs and/or the short-term radio performance indicators and one or more machine learning models, wherein the application layer KPMs characterize end user application performance; and
(v) operate the RAN using the predicted application layer KPMs.
